(19) United States
(12) Patent Application Publication
(10) Pub. No.: US 2025/0240604 A1
(43) Pub. Date: Jul. 24, 2025

(54) SENDING WIRELESS MESSAGES TO MOBILE DEVICES FOR AN ALERTING EVENT

(71) Applicant: QUALCOMM Incorporated, San Diego, CA (US)

(72) Inventor: Stephen William EDGE, Escondido, CA (US)

(21) Appl. No.: 18/416,016

(22) Filed: Jan. 18, 2024

(51) Int. Cl. H04W 4/12; H04W 4/90; H04W 72/23

(52) U.S. Cl. CPC H04W 4/12; H04W 4/90; H04W 72/23

(57) ABSTRACT

A user equipment (UE) may receive a wireless message, broadcast by a network node, that indicates an alerting event. The UE may store the wireless message and transmit the wireless message to a second UE at a later time and via a sidelink interface. The second UE may similarly transmit the wireless message via a sidelink interface to other UEs. The transmission of the wireless message between pairs of UEs may enable the wireless message to reach more UEs in a target area when network nodes have been damaged or disabled, e.g., by the alerting event. The wireless message may be a WEA message and the alerting event may be a natural or man-made disaster.

### FIELD OF THE DISCLOSURE

Aspects of the present disclosure generally relate to wireless communication and specifically relate to techniques, apparatuses, and methods for sending wireless messages to mobile devices related to an alerting event.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). These multiple-access technologies have been adopted in various telecommunication standards to provide common protocols that enable different wireless devices to communicate on a municipal, national, regional, and even global level. The adoption of these protocols enables a wide range of services including Wireless Emergency Alert (WEA) systems. A WEA system typically enables public warning or alert messages to be broadcast from one or more wireless networks to some or all wireless devices currently accessing these wireless networks. Warning or alert messages can indicate the imminence or occurrence of various threats and hazards, both natural and man-made, such as earthquakes, wildfires, flooding, hurricanes, tornadoes, chemical spills, military attacks etc., and can indicate actions that citizens can or should take to protect themselves, their property and others. It may also be necessary to deliver warning and alert messages only to users in affected areas and not to users elsewhere in order to reduce or avoid unnecessary panic and confusion and ensure that users in affected areas will treat warning and alert messages seriously. It may further be necessary to deliver warning and alert messages to users in affected areas even when network infrastructure to support the delivery has been damaged or impaired, e.g., from the threats and hazards for which the warning and alert messages are to be delivered.

Methods and techniques to ensure that warning and alert messages can be reliably, efficiently and quickly delivered to users in affected areas, even when network infrastructure to support the delivery has been damaged or impaired, may therefore be desirable.

### BRIEF DESCRIPTION OF THE DRAWINGS

The appended drawings illustrate some aspects of the present disclosure, and are not limited by the scope of the present disclosure because the description may enable other aspects. Each of the drawings is provided for purposes of illustration and description, and not as a definition of the limits of the claims.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram of an example of a wireless emergency alert (WEA) system, in accordance with the present disclosure.

FIG. 4A is a diagram of an example alert message flow using a WEA transport service, in accordance with the present disclosure.

FIG. 4B shows an example user interface displaying an emergency alert, in accordance with the present disclosure.

FIG. 5 is a diagram of an example network architecture for providing wireless emergency alerts, in accordance with the present disclosure.

FIGS. 6A-6B, 7, and 8 are diagrams illustrating examples associated with sending wireless messages to mobile devices for an alerting event, in accordance with the present disclosure.

FIG. 9 is a flowchart illustrating an example process performed, for example, by a UE, in accordance with the present disclosure.

FIG. 10 is a diagram of an example apparatus for wireless communication, in accordance with the present disclosure.

Like reference symbols in the various drawings indicate like or similar elements, in accordance with certain example implementations. In addition, multiple instances of an element may be indicated by following a first number for the element with a letter. For example, multiple instances of an element 110 may be indicated as 110a, 110b, 110c, etc. When referring to such an element using only the first number, any instance of the element is to be understood (e.g., element 110 in the previous example would refer to elements 110a, 110b, and 110c).

### SUMMARY

In some implementations, an apparatus for wireless communication at a first user equipment (UE) includes one or more memories; and one or more processors, coupled to the one or more memories, configured to cause the first UE to: receive, at a first time, a wireless message that indicates an alerting event; and transmit, via a sidelink interface and at a second time that occurs after the first time, the wireless message to a second UE in accordance with a store-and-forward operation.

In some implementations, a method of wireless communication performed by a first UE includes receiving, at a first time, a wireless message that indicates an alerting event; and transmitting, via a sidelink interface and at a second time that occurs after the first time, the wireless message to a second UE in accordance with a store-and-forward operation.

In some implementations, a non-transitory computer-readable medium storing a set of instructions for wireless communication includes one or more instructions that, when executed by one or more processors of a first UE, cause the first UE to: receive, at a first time, a wireless message that indicates a presence of a natural disaster; and transmit, via a sidelink interface and at a second time that occurs after the first time, the wireless message to a second UE in a target area in accordance with a store-and-forward operation.

In some implementations, a first apparatus for wireless communication includes means for receiving, at a first time, a wireless message that indicates an alerting event; and means for transmitting, via a sidelink interface and at a second time that occurs after the first time, the wireless message to a second apparatus in accordance with a store-and-forward operation.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### DETAILED DESCRIPTION

Various aspects of the present disclosure are described hereinafter with reference to the accompanying drawings. However, aspects of the present disclosure may be embodied in many different forms and are not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

During a disaster event which may include both natural and man-made disasters (e.g., wildfires. hurricanes, tornadoes, pandemics, earthquakes, volcanic eruptions, tsunamis, acts of terrorism, acts of war, nuclear power plant accidents), a wireless message, such as a wireless emergency alert (WEA) message, may need to be transmitted from one or more network nodes to user equipments (UEs) in an affected (or likely to be affected) area. The wireless message may indicate a warning associated with the disaster event. However, the disaster event may damage or destroy some network nodes (or otherwise make some network nodes inoperable), such that the network nodes may be unable to broadcast the wireless message to UEs in the affected area. An emergency system, such as a WEA system, may also itself be disabled by the same disaster event that the WEA system is intended to protect against, which may result in some or all UEs in the affected area not receiving the wireless message from a network node.

The emergency system may be upgraded to overcome such limitations. For example, the emergency system may be upgraded to support the transmission of wireless messages via a satellite, where the satellite is less likely to be impaired or affected by the disaster event. However, not all UEs may have a satellite capability, and in some cases, access to satellites may be restricted. As another example, the emergency system may be upgraded to support the transmission of wireless messages via sidelink signaling, also referred to as device to device (D2D) signaling. In this example, a wireless message may be relayed from a UE with wireless coverage (e.g., with access to a network node that was not impaired) to other UEs without wireless coverage, using sidelink signaling. However, using sidelink signaling to extend an effective message coverage may be limited because a UE relaying a wireless message must necessarily have access to a network node. Therefore, a wireless coverage area may only be extended outwards by a maximum sidelink signaling distance between a pair of UEs (e.g., 1-3 km).

In some cases, a wireless message may be relayed over a chain of UEs (e.g., 2 or 3 UEs) using sidelink signaling, but the extension of the effective message coverage may still be limited by a maximum number of UEs allowed or included in the chain and/or a requirement that UEs are within a certain distance from each other when an initial UE receives a wireless message from the network node. Further, relaying wireless messages using sidelink signaling may be limited to being relayed in real-time, so only UEs that are proximately located to a transmitter and/or relay UE (e.g., within 1-3 km of the transmitter and/or relay UE) are able to receive the wireless message. As a result, during the disaster event, relying on sidelink signaling with such limitations may limit a number of UEs that are able to receive the wireless message using sidelink signaling, which may degrade an overall system performance.

Various aspects relate generally to transmitting wireless messages during or for an alerting event. An alerting event can be a disaster event where people, animals and/or property are at risk or can be a milder event where people need to be made aware of the event but where human life, animal life and property are not directly at risk. An example of a disaster event could be a hurricane, tornado or wildfire. An example of an alerting event that is not a disaster event could be total or partial loss of coverage by a public or private communication network, a road closure or cancellation of certain road, rail or airline transport. The WEA system described here is generally intended to support disaster events. However, the wireless messages described here to warn users about alerting events can apply to alerting events that both comprise and do not comprise disaster events. In the description herein, the terms alerting event and disaster event are sometimes used interchangeably.

Some aspects of sending wireless messages for an alerting event more specifically relate to transmitting the wireless messages using sidelink signaling. In some examples, a first UE may receive, from a network node via a broadcast, a wireless message that indicates a presence of an alerting event. The alerting event may involve a natural disaster, a man-made disaster, and/or a loss of coverage to a wireless network. The wireless message may be a WEA message. The first UE may receive the wireless message at a first time and at a first location. The first UE may store the wireless message in a memory of the first UE. The first UE may be in-coverage with the network node when the wireless message is received from the network node. The first UE may be a mobile UE, such that the first UE may move from the first location to a second location. At the second location, the first UE may transmit, to a second UE, the wireless message in accordance with a store-and-forward operation. The first UE may transmit the wireless message to the second UE when the second UE is in a target area for the wireless message. The first UE may transmit the wireless message at a second time that occurs after the first time. The second UE that receives the wireless message may be out-of-coverage with the network node. The first UE may receive the wireless message and transmit the wireless message using a same RAT or different RATs. The first UE may transmit the wireless message using the store-and-forward operation, where the store-and-forward operation may be associated with a diffusion time. The diffusion time may be based at least in part on an extent of a backhaul outage for the network node due to the disaster event and/or a size of the target area. The target area may be a target WEA area.

Particular aspects of the subject matter described in this disclosure can be implemented to realize one or more of the following potential advantages. In some examples, by using the store-and-forward operation to relay a wireless message, instead of only relaying wireless messages in real-time, the described techniques can be used by a first UE to relay or forward wireless messages to a plurality of UEs within a target area. A time needed to forward a wireless message to all UEs in a target area may be referred to as a diffusion time, since a process of forwarding a wireless message by UEs which move into and/or around a target area can be similar to a physical process of diffusion. For example, a diffusion time may be less than a minute to several hours, depending on a size of the target area, a speed and mobility of the UEs which forward the wireless message and a density of UEs in the target area. The first UE may be able to store the wireless message received from a network node, and then the first UE may forward the wireless message to other UEs within the target area (e.g., UEs that have not already received the wireless message). Typically, a sidelink interface is intended to provide real-time access to a wireless network. However, since the first UE may move to different locations within a target area, which may be larger than a coverage area of a network node, an effective message coverage may be extended beyond a maximum sidelink signaling distance (e.g., beyond 1-3 km). As a result, a larger number of UEs within a target area may be able to receive the wireless message, which may improve an overall system performance.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

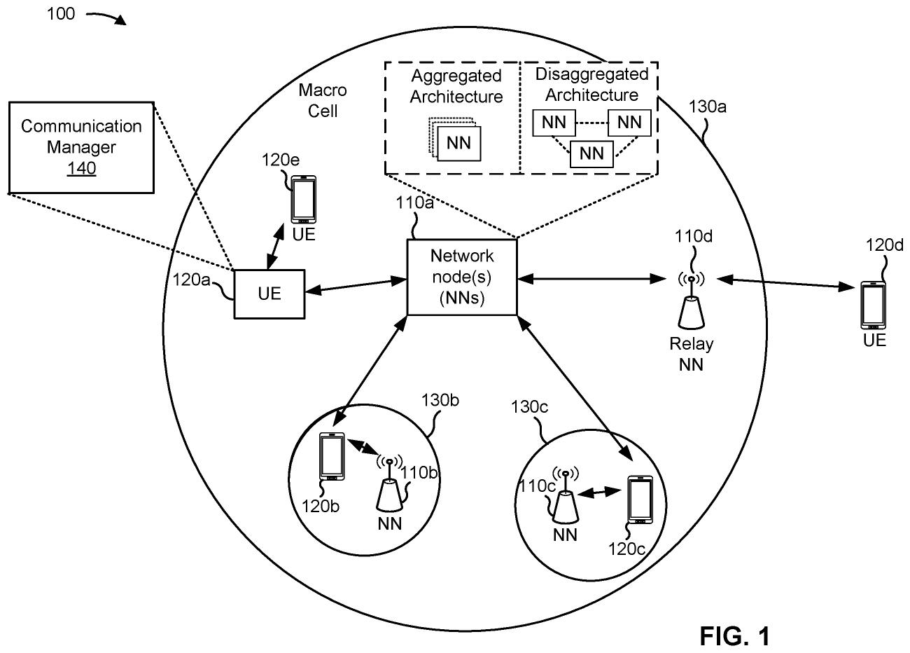

FIG. 1 is a diagram illustrating an example of a wireless communication network 100 in accordance with the present disclosure. The wireless communication network 100 may be or may include elements of a 5G network that may support New Radio (NR) or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e. Network nodes 110 may include base stations which may be terrestrial and may communicate with UEs 120 via terrestrial signaling. Alternatively, network nodes 110 may be non-terrestrial (e.g., onboard a satellite) and/or may communicate with UEs 120 via signaling through a satellite. UEs 120 may be referred to as mobile devices, mobile stations, wireless terminals or by other names.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular radio access technology (RAT) (which may also be referred to as an air interface) and may operate on one or more carrier frequencies in one or more frequency ranges. Examples of RATs include a 4G RAT such as Long Term Evolution (LTE), a 5G RAT such as NR, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHz), FR3 (7.125 GHz through 24.25 GHZ), FR4a or FR4-1 (52.6 GHz through 71 GHz), FR4 (52.6 GHZ through 114.25 GHz), and FR5 (114.25 GHz through 300 GHz). Although a portion of FR1 is greater than 6 GHz, FR1 is often referred to (interchangeably) as a “Sub-6 GHZ” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the Third Generation Partnership Project (3GPP). In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a non-terrestrial network (NTN) network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This can enable more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System (GPS) device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G NR, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”). An MTC UE may be, may include, or may be included in or coupled with a robot, a crewed or uncrewed aerial, land or maritime vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category May facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, Proximity Services (ProSe) communication protocols (e.g., as defined by 3GPP), device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols). In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications. Sidelink communication may employ frequencies in unlicensed spectrum, frequencies in operator licensed spectrum and/or frequencies in spectrum reserved for particular types of communication such as spectrum assigned for Intelligent Transport Services (ITS) or for public safety usage.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and UL transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform Multiple-Input Multiple-Output (MIMO) communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, a first UE (e.g., 120a) may include a communication manager 140. As described in more detail elsewhere herein, the communication manager 140 may receive, at a first time, a wireless message that indicates an alerting event; and transmit, via a sidelink interface and at a second time that occurs after the first time, the wireless message to a second UE (e.g., UE 120e) in accordance with a store-and-forward operation. Additionally, or alternatively, the communication manager 140 may perform one or more other operations described herein.

As indicated above, FIG. 1 is provided as an example. Other examples may differ from what is described with regard to FIG. 1.

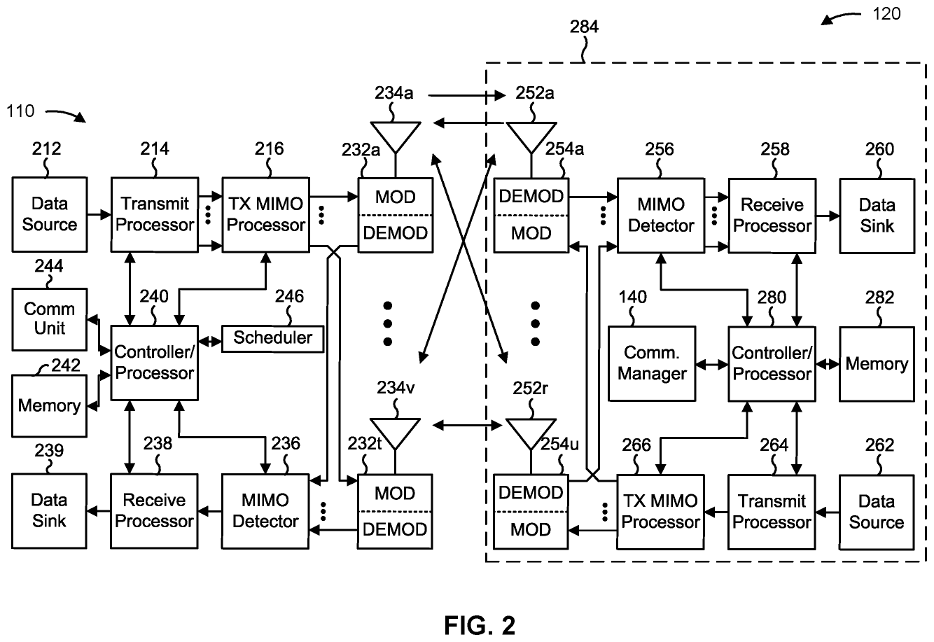

FIG. 2 is a diagram illustrating an example network node 110 in communication with a UE 120 in a wireless network (e.g., the wireless communication network 100) in accordance with the present disclosure.

As shown in FIG. 2, the network node 110 may include a data source 212, a transmit processor 214, a transmit (TX) MIMO processor 216, a set of one or more modems 232 (shown as 232a through 232t), a set of one or more antennas 234 (shown as 234a through 234v), a MIMO detector 236, a receive processor 238, a data sink 239, a controller/processor 240, a memory 242, a communication unit 244, and a scheduler 246, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of one or more antennas 252 (shown as antennas 252a through 252r), a set of one or more modems 254 (shown as modems 254a through 254u), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

Sidelink communication between a pair of UEs 120 (e.g., UE 120a and UE 120e) may employ the elements for UE 120 shown and described in FIG. 2 for each UE of the pair of UEs 120, where transmission of UL signals or communication by a UE 120 as described in FIG. 2 now refers to transmission of sidelink communication or signals by the UE 120, and where reception of DL signals or communication by a UE 120 as described in FIG. 2 now refers to reception of sidelink signals or communication by the UE 120.

In some aspects, a first UE (e.g., UE 120a) includes means for receiving, at a first time, a wireless message that indicates an alerting event; and/or means for transmitting, via a sidelink interface and at a second time that occurs after the first time, the wireless message to a second UE (e.g., UE 120e) in accordance with a store-and-forward operation. The means for the first UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

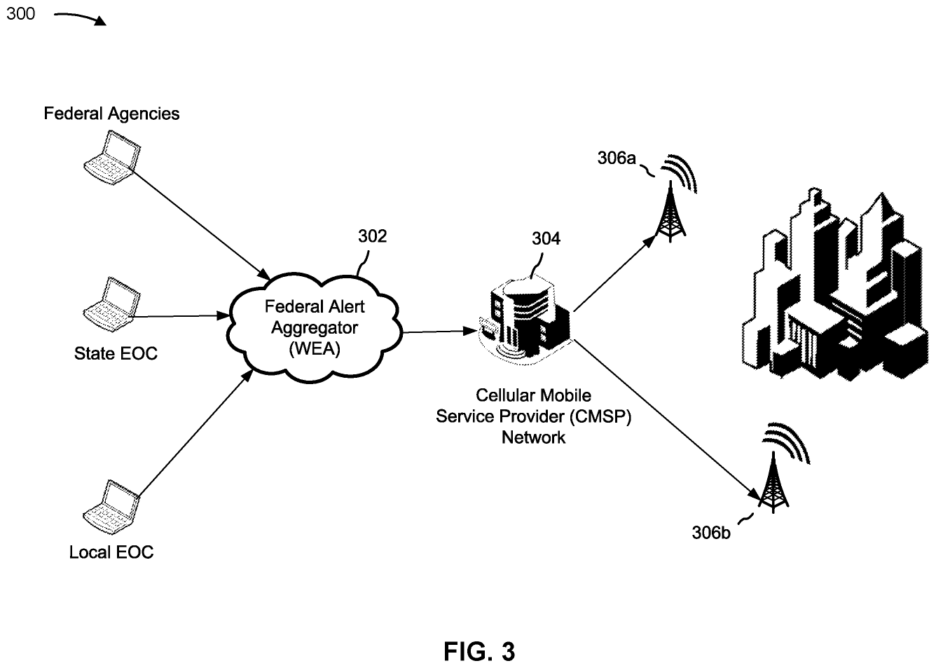

FIG. 3 is a diagram of an example 300 of a WEA system, in accordance with the present disclosure.

As shown in FIG. 3, the WEA system may be configured to utilize radio frequency broadcast technology to provide geographically-targeted and timely alert messages to UEs (e.g., UEs 120). An alert message may be a message that is intended to provide the recipient with information regarding an emergency and that meets the requirements of regional regulations. For example, the WEA system may generate and provide alert messages to notify users about a geographically specific emergency such as an earthquake, a tsunami, a flood, a tornado, a wildfire, an act of terrorism, a child abduction (e.g., an AMBER alert), a possible nuclear missile attack, local riots, or other types of emergency events.

In many countries, cellular mobile service providers (CMSPs) 304 (sometimes referred to herein as “providers”) may be required to transmit alert messages that comply with agreed-upon standards, protocols, and/or procedures. As an example, standards, protocols, and/or procedures applicable to WEA support in the United States may be provided by the Alliance for Telecommunications Industry Solutions (ATIS), the Telecommunications Industry Association (TIA), and/or joint ATIS/TIA groups. An example of a related standard is Joint ATIS/TIA Commercial Mobile Alert System (CMAS) Federal Alert Gateway to CMSP Gateway Interface Specification (J-STD-101). The alert message processes controlled by a CMSP 304 may also be required to comply with local and/or federal government regulations (e.g., regulations adopted by the U.S. Federal Communications Commission (FCC) and state or county emergency preparedness procedures). Government collaboration with the WEA system may be provided by the FCC, Federal Emergency Management Agency (FEMA), and/or Department of Homeland Security (DHS).

In operation, alert messages may originate from federal agencies, local emergency operations centers (EOCs), and state EOCs. Alert messages may also originate from other sources. An alert message may be triggered by various types of emergencies, such as an earthquake, a tsunami, a flood, a tornado, a wildfire, an act of terrorism, acts of war, civil unrest, and/or child abduction (e.g., an AMBER alert). Alert messages originating from various sources (e.g., federal agencies, local EOCs, and state EOCs) may be provided to an alert aggregator 302. In some configurations, the alert aggregator 302 may authenticate the alert messages. Authentication may involve checking the authenticity of the alert message to confirm that the alert message was transmitted by an authorized source, in order to prevent unauthorized sources (e.g., terrorist, hackers, hostile foreign states, etc.) from causing fraudulent alert messages to be disseminated to UEs using the WEA system. The alert aggregator 302 may provide the alert messages to the CMSP 304 (and possibly to other CMSPs), which is prepared to transmit alert messages to UEs accessing CMSP 304 via one or more network transmitters 306a-b which may correspond to network nodes 110 (e.g., which may include cellular base stations, base stations with satellite access or satellite capability and possibly other transmitters such as WiFi access points). In some configurations, the alert aggregator 302 may be administered by a governmental entity (e.g., a federal, state, local agencies).

The CMSP 304 may include one or more systems and/or personnel to determine or verify the severity of an emergency (referred to as “severity information”) as well as a geographic area associated with the emergency, which may also be provided by the alert aggregator 302. This geographic area may be referred to as the impacted area, impact area, target area, affected area, or target geographic area, these terms being used synonymously herein. For example, one or more systems and personnel in the CMSP 304 may verify that a notification received from the alert aggregator 302 regarding a potential tornado touch down has a high severity, and that the corresponding impacted area (e.g., the predicted tornado touch down area) includes areas covered by the CMSP 304 network resources such as the transmitters 306a-b. A provider may utilize various components of the CMSP 304 network to generate and transmit an alert message to UEs within the target geographic area (or within a portion of the target geographic area served by CMSP 304). In an example, the WEA system may utilize broadcast technology such that one or more alert messages may be provided simultaneously to all UEs in the target geographic area.

As indicated above, FIG. 3 is provided as an example. Other examples may differ from what is described with regard to FIG. 3.

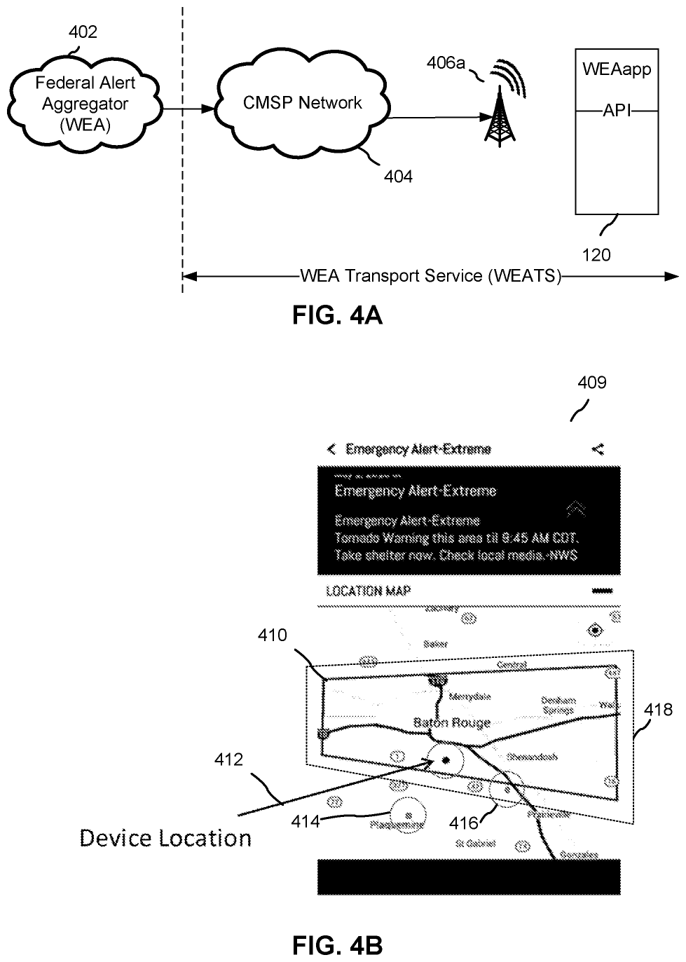

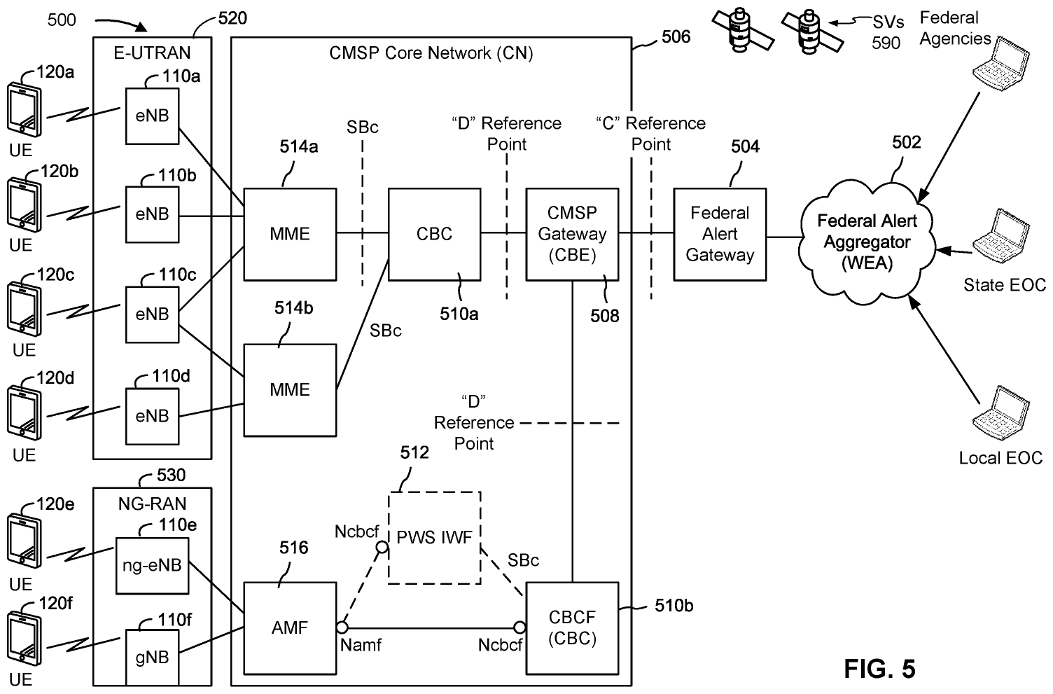

FIG. 4A is a diagram of an example of an alert message flow using a WEA transport service, in accordance with the present disclosure.

As shown in FIG. 4A, an alert message flow may use a WEA transport service (WEATS). An alert aggregator 402 may be configured to receive alert information from verified sources such as federal agencies and state/local EOCs (not shown in FIG. 4A). The alert information is then provided to a CMSP network 404. The CMSP network 404 may be configured to generate alert messages including geographic boundaries and broadcast the alert messages to one or more UEs 120 via one or more transmitters 406a (e.g., which may comprise network nodes 110).

As indicated above, FIG. 4A is provided as an example. Other examples may differ from what is described with regard to FIG. 4A.

FIG. 4B shows an example user interface displaying an emergency alert, in accordance with the present disclosure.

As shown in FIG. 4B, the alert messages may be broadcast (e.g., by network nodes 110) using one or more system information blocks (SIBs) (e.g., a SIB12). The alert message may include an indication of an impacted area such as a target geographic area defined by a polygon, circle, ellipse, or some other shape (or shapes). A UE 120 may include a software application (e.g., WEAapp) configured to parse and process the information contained in the alert message. For example, the UE 120 may execute the WEAapp to display an alert message 409. The alert message 409 may indicate (in this example) a polygon area 410 representing a geographic boundary line of the impacted area indicated in the alert message. The process of displaying the alert message on the UE 120 may be based on the current location of the UE 120. For example, when the UE 120 is located at a first position 412 that is within the polygon area 410, then the UE 120 will display the alert message 409. Conversely, when the UE 120 is located in a second position 414 which is outside the polygon area 410, the alert message may not be displayed. In an example, a boundary area 418, also referred to as a “border area” 418, outside of and surrounding the polygon area 410 may be defined. The boundary area 418 may extend the polygon area 410 outward by a predetermined value (e.g., by outwardly extending the boundary of the impact area by 0.1, 0.2 or 0.5 miles in one, some, or all directions). A UE 120 apparently located at a third position 416 that is outside the polygon area 410 but within the boundary area 418 may optionally display an alert message based on other factors such as the severity of the emergency, user preferences, CMSP preferences, and/or an uncertainty of the position of the UE 120.

As indicated above, FIG. 4B is provided as an example. Other examples may differ from what is described with regard to FIG. 4B.

FIG. 5 is a diagram of an example 500 of a network architecture for providing wireless emergency alerts, in accordance with the present disclosure.

As shown in FIG. 5, alert messages originating from various sources (e.g., federal agencies, local EOCs, and state EOCs) may be provided to an alert aggregator 502 for dissemination to network providers. In an example, the alert aggregator 502 may provide the alerts to a federal alert gateway 504 configured to authenticate the alert messages to prevent fraudulent alerts from being broadcast by a WEA system.

A CMSP core network (CN) 506 may receive alerts including impact area information from the federal alert gateway 504. The CMSP core network 506 may include a CMSP gateway 508 configured to verify and reformat incoming messages and distribute the messages to one or more cell broadcast centers (CBCs). The CMSP gateway 508 may also be referred to as cell broadcast entity (CBE). A CBC 510a may be used in an LTE architecture and a CBC function (CBCF) 510b may be used in a 5G architecture. The CBC 510a and the CBCF 510b (collectively referred to as CBCs 510) may be configured to retain information to identify tracking areas, emergency areas, and/or cell ID lists for an alert, until the alert is canceled or the alert expires. The CBCs 510 may determine network elements for a WEA alert to include in a broadcast. The CBCs 510 may pass alert messages to one or more mobility management entities (MMEs) 514a-b via an SBc interface. In one variant, the CBCF 510b may pass an alert message directly to an access and mobility management function (AMF) 516 using a service-based interface. In another example, an alert message may be transferred by CBCF 510b to a public warning system interworking function (PWS IWF) 512 using an SBc interface. The PWS IWF 512 may then perform protocol translation and transfer the alert message to AMF 516 using a service-based interface.

The CBCs 510 (e.g., CBC 510a and CBCF 510b) may decide in which cells (or in which tracking areas or emergency areas, which may map to cells) an alert message needs to be broadcast, based on the impact area. The CBCs 510 may receive a description or definition of the impact area along with the alert message and a required frequency and duration of transmission for the alert message from the CMSP gateway 508, which in turn may receive at least the description or definition of the impact area and the alert message from federal alert gateway 504. The impact area may be defined as a polygon, ellipse, circle or some other 2-dimensional (or 3-dimensional) shape or shapes. The CBCs 510 may determine the wireless cells (or possibly the tracking areas or emergency areas), for radio access networks (RANs) attached to CMSP CN 506, which are within or at least partly within the impact area. The CBCs 510 may determine a list of cells (or tracking areas or emergency areas) and send the alert message to one or more MMEs 514a-b and/or one or more AMFs 516 along with the list of cells (or tracking areas or emergency areas).

In some cases, a CBC 510 may only transfer, to an MME 514 or AMF 516, a list of cells (or tracking areas or emergency areas) which can be accessed from network nodes 110 connected to or reachable from the MME 514 or AMF 516. For example, the CBC 510 may partition a complete list of cells corresponding to the target area into different non-overlapping subsets of cells, where each subset of cells is transferred to a different MME 514 or AMF 516. The CBC 510 may also transfer to each MME 514 and AMF 516 an indication of one or more tracking areas in which the alert message needs to be broadcast, which may be used by an MME 514 or AMF 516 to determine network nodes 110 (e.g., eNBs, ng-eNBs and/or gNBs) to which the alert message should be transferred for possible broadcast.

The MMEs 514 and AMF 516 may normally support network access and registration by UEs 120, mobility of UEs 120, including cell change and handover, and may participate in supporting a signaling connection to a UE 120 and possibly data and voice bearers for a UE 120. The MMEs 514 may transfer an alert message along with a list of cells to one or more of eNBs 110a-d in an Evolved Universal Mobile Telecommunications System (UMTS) Terrestrial Radio Access (E-UTRAN) 520, as determined using the indication of the one or more tracking areas provided by CBC 510a. The AMF 516 may perform a corresponding role with respect to transferring the alert message along with a list of cells to one or more of gNBs 110f and/or ng-eNBs 110e in a Next Generation RAN (NG-RAN) 530, as determined using the indication of the one or more tracking areas provided by CBCF 510b. The gNB 110f may support wireless access using NR by a UE 120f, the ng-eNB 110e may support wireless access using LTE for a UE 120e (but with communication passing through AMF 516 rather than an MME 514), and the eNBs 110a-d may support wireless access using LTE by UEs 120a-d. The network nodes 110, comprising the eNBs 110a-d, ng-eNB 110e, and gNB 110f, may broadcast the alert message (e.g., using a SIB12), including the target area shape, to UEs 120 in their respective coverage areas. The broadcast may occur in each cell that is indicated to a network node 110 in association with the alert message by an MME 514 or AMF 516.

The network architecture may be associated with or have access to space vehicles (SVs) 590 for a global navigation satellite system (GNSS) like GPS, Galileo, Beidou, or some other local or regional satellite positioning system (SPS). The UEs 120 may obtain location measurements for signals transmitted by SVs 590 and/or by network nodes 110 and access points such as eNBs 110a-d, ng-eNB 110e, and/or gNB 110f, which may enable a UE 120 to determine a location estimate for UE 120 or to obtain a location estimate for UE 120 from a location server in CMSP CN 506. For example, the UE 120 may transfer location measurements to the location server to compute and return the location estimate. The UEs 120 (or a location server in CMSP CN 506) may obtain a location estimate for UE 120 using position techniques such as GPS, assisted GPS (A-GPS), assisted GNSS (A-GNSS), observed time difference of arrival (OTDOA), enhanced cell ID (ECID), wireless local area network (WLAN) positioning (e.g., using signals transmitted by IEEE 802.11 WiFi access points), and/or sensors (e.g., inertial sensors) in the UE 120. The UE 120 may use a location estimate for the UE 120 to determine or help determine whether the UE 120 is in an impact area for a broadcast alert message.

As indicated above, FIG. 5 is provided as an example. Other examples may differ from what is described with regard to FIG. 5.

During a disaster event (e.g., wildfires), a wireless message, such as a WEA message, may not be transmitted from a network node to a UE in an affected area. The wireless message may indicate a warning associated with the disaster event. The disaster event may destroy the network node (or otherwise make the network node inoperable), such that the network node may be unable to broadcast the wireless message to the UE in the affected area. An emergency system, such as a WEA system, may itself be disabled by the same disaster event that the WEA system is intended to protect against, which may result in the UE not receiving the wireless message from the network node.

The emergency system may be upgraded to overcome such limitations. For example, the emergency system may be upgraded to support the transmission of wireless messages via a satellite (e.g., via a network node 110 that has access to one or more satellites). However, not all UEs may have a capability to access a satellite, and in some cases, access to certain satellites may be restricted (e.g., if a UE is indoors, has no line of sight to a satellite or currently has no coverage from a satellite). As another example, the emergency system may be upgraded to support the transmission of wireless messages via sidelink signaling. A wireless message may be relayed from a UE with wireless coverage to other UEs without wireless coverage, using sidelink signaling. However, using sidelink signaling to extend an effective message coverage may be limited because a wireless coverage area may only be extended outwards by a maximum sidelink signaling distance between a pair of UEs (e.g., 1 to 3 kms). In some cases, a wireless message may be relayed over a chain of UEs (e.g., 2 or 3 UEs) using sidelink signaling, but the extension of the effective message coverage may still be limited by a maximum number of UEs allowed in the chain and/or a requirement that UEs are within a certain distance from each other when an initial UE receives a wireless message from a network node. Further, relaying wireless messages using sidelink signaling may be limited to being relayed in real-time, so only UEs that are proximately located to a transmitter UE (e.g., within 1 to 3 kms of the transmitter UE) are able to receive the wireless message. As a result, during a disaster event, relying on sidelink signaling with such limitations may limit a number of UEs that are able to receive the wireless message using sidelink signaling, which may degrade an overall system performance.

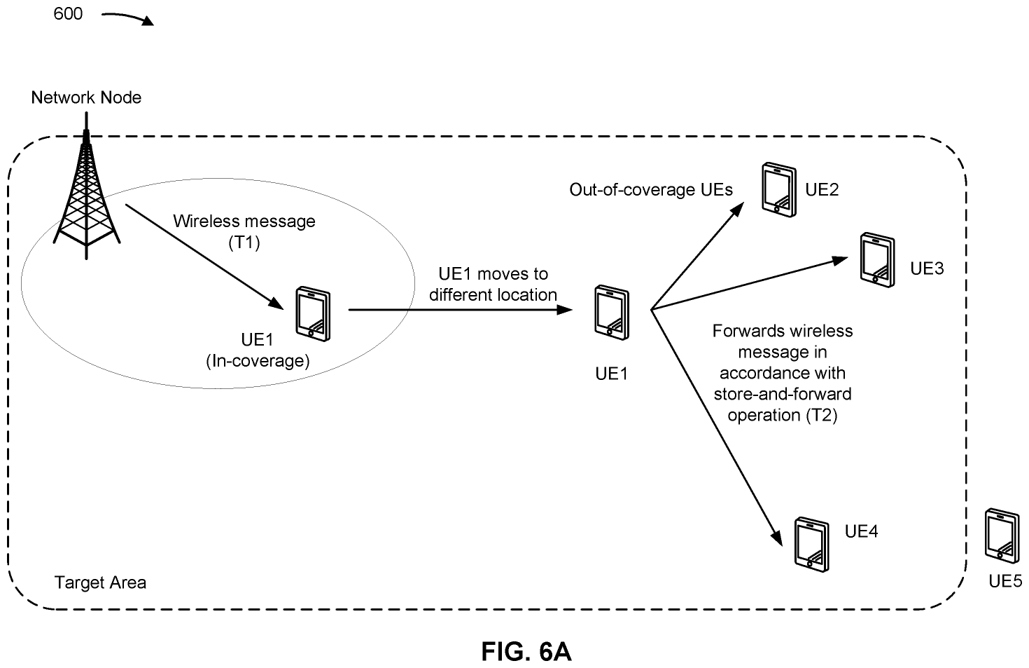

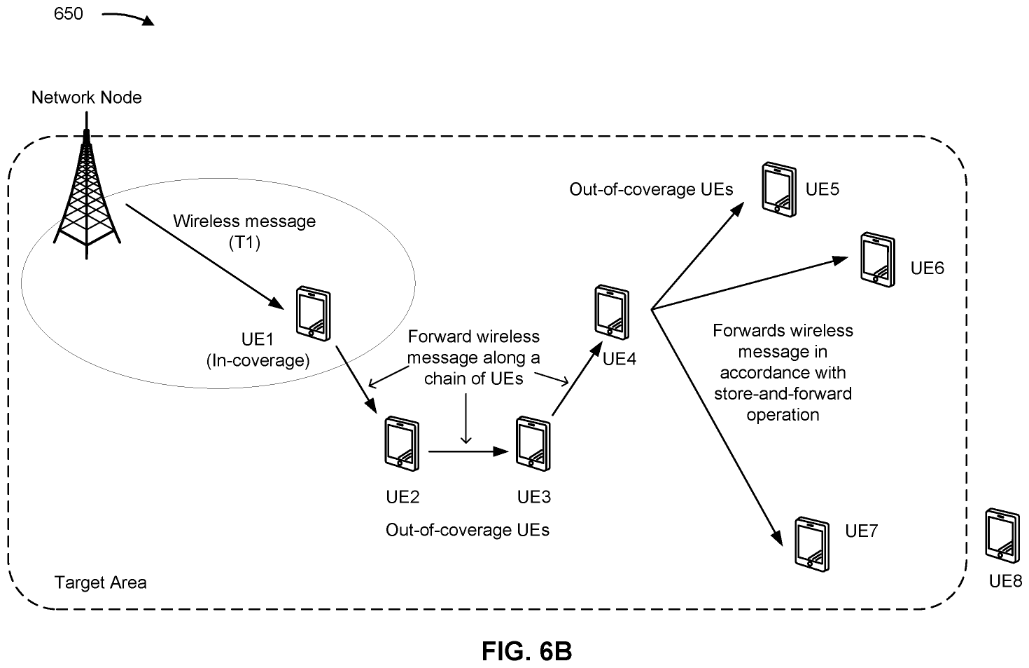

FIG. 6A is a diagram illustrating an example scenario 600 associated with transmitting wireless messages during an alerting event, in accordance with the present disclosure.

As shown in FIG. 6A, a first UE (UE1) may receive a wireless message from a network node (e.g., a network node 110), as described for the examples in FIGS. 3-5. The first UE may be in-coverage with the network node. The first UE may receive the wireless message at a first time (T1). The first UE may receive the wireless message when the first UE is at a first location. The first UE may then move from the first location to a second location. At the second location and at a second time (T2), the first UE may forward the wireless message to a plurality of UEs that are within a target area, which may include a second UE (UE2), a third UE (UE3), and a fourth UE (UE4). The second UE, the third UE, and the fourth UE may be out-of-coverage with the network node but still within the target area. The first UE may forward the wireless message to the plurality of UEs in accordance with a store-and-forward operation. The first UE may not forward the wireless message to a fifth UE (UE5), which may be outside of the target area.

As indicated above, FIG. 6A is provided as an example. Other examples may differ from what is described with regard to FIG. 6A.

In FIG. 6A, the wireless message is transferred to other UEs partly through the movement of the first UE. If the first UE did not move, then the wireless message transfer to the second UE, the third UE, and the fourth UE might not be possible due to distances between the first UE and each of the other UEs that exceed a maximum distance for sidelink signaling. The method of transfer shown in FIG. 6A can thus involve diffusion of UEs that have received the wireless message into other parts of a target area where they are then able to transfer the wireless message to other UEs.

FIG. 6B is a diagram illustrating an example scenario 650 associated with transmitting wireless messages during an alerting event, in accordance with the present disclosure. In FIG. 6B, in contrast to FIG. 6A, UEs do no have to move in order to transfer a wireless message.

As shown in FIG. 6B, a first UE (UE1) may receive a wireless message from a network node (e.g., a network node 110), as described for the examples in FIGS. 3-5. The first UE may be in-coverage with the network node. The first UE may receive the wireless message at a first time (T1). The first UE may receive the wireless message when the first UE is at a first location. The first UE may remain at or near to the first location. At a second time (T2), the first UE may forward the wireless message to a second UE (UE2) that is at a second location within the target area. The second UE may remain at or near to the second location. At a third time (T3), the second UE may forward the wireless message to a third UE (UE3) that is at a third location within the target area. The third UE may remain at or near to the third location. At a fourth time (T4), the third UE may forward the wireless message to a fourth UE (UE4) that is at a fourth location within the target area. The fourth UE may remain at or near to the fourth location. At a fifth time (T5), the fourth UE may forward the wireless message to a plurality of UEs that are within the target area, which may include a fifth UE (UE5), a sixth UE (UE6), and a seventh UE (UE7). The second, third, fourth, fifth, sixth and seventh UEs may be out-of-coverage with the network node but still within the target area. The forwarding of the wireless message from UE1 to UE2, UE2 to UE3, UE3 to UE4 and UE4 to UE5. UE6 and UE7 may be in accordance with a store-and-forward operation. The fourth UE may not forward the wireless message to an eighth UE (UE8), which may be outside of the target area.

As indicated above, FIG. 6B is provided as an example. Other examples may differ from what is described with regard to FIG. 6B.

In FIG. 6B, the wireless message is transferred to other UEs by means of transfer along a chain of UEs, where UEs involved in the transfer do not necessarily move. The method of transfer shown in FIG. 6B can thus involve diffusion of the wireless message into other parts of a target area rather than diffusion of UEs that carry the wireless message as in FIG. 6A. The method of transfer shown in FIG. 6B may be faster than the method shown in FIG. 6A because transfer of a wireless message can occur without any delay for movement of a UE, For example, if each UE that receives a wireless message (e.g., from a network node or from another UE) is able to transfer the wireless message using store and forward operation to other UEs nearby to the UE in a few seconds, it could be possible to transfer the wireless message to most or all UEs in a target area that are out of coverage of network nodes in less than a minute or in a few minutes. In some scenarios, transfer of a wireless message to UEs in a target area may include transfer as in FIG. 6A and transfer as in FIG. 6B.

It is noted that transfer of a wireless message along a chain of UEs using store and forward operation, as exemplified in FIG. 6B, can differ from real time transfer of a wireless message along a chain of UEs. With transfer of a wireless messages along a chain of UEs in real time, sidelink connections or links between pairs of UEs in the chain of UEs may need to be established prior to transfer of a wireless message. After the sidelink connections or links are established, a second UE that receives a wireless message from a first UE using a first sidelink connection can immediately send the wireless message to a third UE using a second sidelink connection that is contemporaneous with the first sidelink connection. This method of transfer could be used (e.g., in FIG. 6B) if pairs of UEs first establish contemporaneous sidelink connections (e.g., with a separate sidelink connection between UEs 1 and 2, UEs 2 and 3, UEs 3 and 4, UEs 4 and 5, UEs 4 and 6 and UEs 4 and 7 in the case of FIG. 6B). Such transfer of a wireless message along a chain of UEs in real time is a variant of store and forward transfer as described previously for FIG. 6B.

It is further noted that the method of wireless transfer illustrated in FIG. 6B may require a higher density of UEs in a target area than the method illustrated in FIG. 6A because each UE needs to be near enough to one or more other UEs in order to allow sidelink transfer of the wireless message without significant movement by any of the UEs.

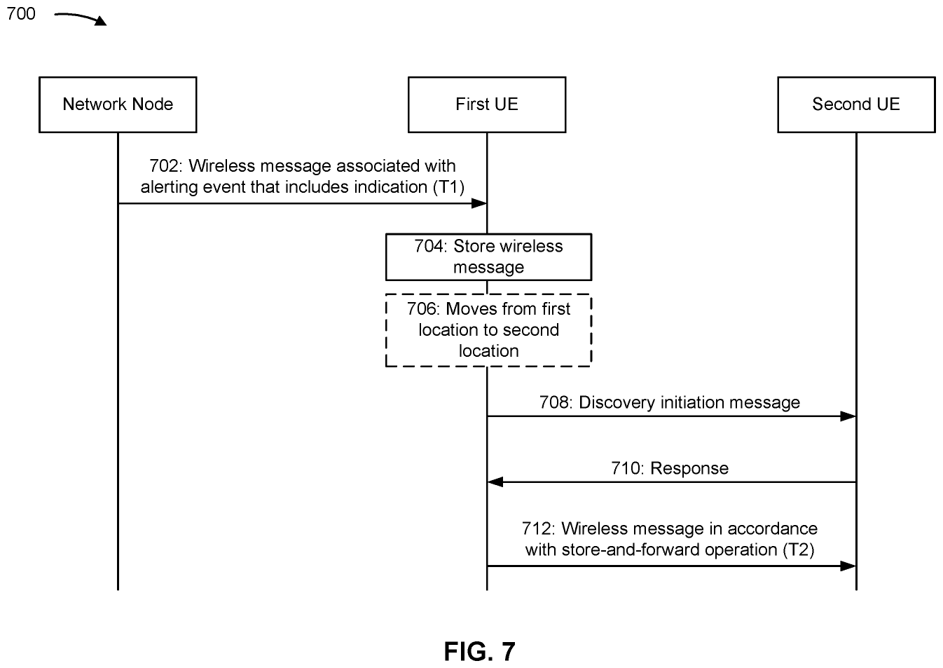

FIG. 7 is a diagram illustrating an example 700 associated with transmitting wireless messages during an alerting event, in accordance with the present disclosure. As shown in FIG. 7, example 700 includes communication between a network node (e.g., network node 110), a first UE (e.g., UE 120a), and a second UE (e.g., UE 120e). In some aspects, the network node, the first UE, and the second UE may be included in a wireless network, such as wireless network 100.

As shown by reference number 702, the first UE may receive, from the network node, a wireless message that indicates an alerting event. The alerting event may involve a natural disaster, a man-made disaster, and/or a loss of coverage to a wireless network. The wireless message may be a WEA message. The first UE may receive the wireless message at a first time (T1) and at a first location. The first UE may receive the wireless message from the network node via a broadcast when the first UE is in-coverage with the network node, e.g., as described for FIGS. 3-5. The wireless message may be indicated using a system information block (SIB, e.g., SIB12). Alternatively, the first UE may receive the wireless message from a third UE (not shown in FIG. 7) via a sidelink interface, where the third UE may have received the wireless message from a network node or from another UE via a sidelink interface.

In some aspects, the wireless network may receive a message indicating a disaster event from a government entity or some other entity, e.g., as described in FIGS. 3 and 5. The message may be sent to various entities before being transmitted to the wireless network (e.g., as described in FIG. 5), which may then forward a corresponding wireless message to the first UE.

In some aspects, the wireless message may be associated with an indication for the first UE to convey the wireless message to other UEs in a target area. The target area may be a target WEA area. The indication and the wireless message may be included in a SIB transmitted by the network node via a broadcast or in a sidelink communication from a third UE. The first UE may be within the target area when the wireless message is received, or alternatively, the first UE may be outside the target area when the wireless message is received. In some aspects, the indication associated with the wireless message may be a flag or other parameter that indicates that the first UE is to convey the wireless message to other UEs and may further indicate a method or methods by which the conveyance to other UEs is to be supported. For example, when the indication is a flag and when the flag is set to ON, the first UE may be configured to automatically convey the wireless message to other UEs in the target area using a particular predefined or preconfigured method.

In an aspect, the network node may include the indication in, or with, the wireless message transmitted by the network node at 702 (e.g., transmitted using the transmit processor 214, transmit MIMO processor 216, modem(s) 232 and antenna(s) 234 shown in FIG. 2), for the first UE to convey the wireless message to other UEs in the target area when an operator for the network node may not be able to broadcast the wireless message throughout all of the target area. For example, the alerting event for the wireless message may correspond to a disaster event (e.g., a hurricane, tornado, tsunami or wildfire) in which some network nodes for the operator of the network node may have been damaged or otherwise rendered inoperable by the disaster event. Some of the damaged or inoperable network nodes may be needed to broadcast the wireless message throughout all of the target area, but may be unable to do so. The operator may then configure the network node or another element or elements (e.g., a CBC, AMF or MME) in a network for the operator to include the indication in, or with, the wireless message that UEs that receive the wireless message (e.g., the first UE) are to convey the wireless message to other UEs in the target area (e.g., the second UE). In these conditions, the network node may also include authentication information in the wireless message or sent in association with the wireless message at 702, as described later herein.

As shown by reference number 704, the first UE may store the wireless message in a memory of the first UE. The first UE may store the wireless message for a certain period of time (e.g., a validity time), after which the first UE may erase the wireless message from the memory of the first UE. The period of time may correspond to an expected duration of the alerting event, an expected duration of a warning for the alerting event or a validity time for the wireless message and may be received at 702 in association with the wireless message or may be preconfigured in the first UE. A validity time may comprise a time, a date or a date and time after which information is the wireless message is no longer valid or (fully) trustworthy.

The first UE may store the wireless message regardless of whether the first UE is in the target area or outside of the target area. The first UE may display the wireless message to a user of the first UE when the first UE is within the target area, or the first UE may not display the wireless message to the user when the first UE is outside of the target area.

As shown by reference number 706, the first UE may move from the first location to a second location. In other words, the UE may be a mobile UE, and after receiving the wireless message at the first location, the first UE may move to the second location. The second location may be different from the first location. The second location may be outside of a coverage area of the network node (e.g., there is no wireless network coverage at the second location). In some aspects, the first UE may remain at or near to the first location and 706 may not occur.

As shown by reference number 708, the first UE may broadcast or transmit, to a second UE, a discovery initiation message that indicates that a purpose of the discovery initiation message is to forward the wireless message. It is noted that the first UE may not be aware of the second UE initially (e.g., at the first time) and thus may broadcast the discovery initiation message to all UEs that may be nearby to the first UE, where the discovery initiation message is received by the second UE.

By transmitting the discovery initiation message, the first UE may advertise that the first UE has the wireless message (or has a wireless message concerning an alerting event) and is able to forward the wireless message. The first UE may transmit the discovery initiation message based at least in part on the indication associated with the wireless message. The first UE may transmit the discovery initiation message at a second time (T2) and may transmit the discovery initiation message after moving to the second location if 706 has occurred. In other words, the first UE may attempt to discover UEs that have not yet received the wireless message and that may be nearby to the first location or nearby to the second location if 706 occurs. The second UE may be out-of-coverage with the network node, but the second UE may still be within the target area. In this case, the target area may not be entirely within a coverage area of the network node and may extend beyond the coverage area of the network node. The first UE may include in the transmission of the discovery initiation message an indication or indications of characteristics of the wireless message, such as a type of wireless message, a type of alerting event, a wireless message identifier or serial number, a target area for the wireless message, and/or an age of the wireless message which may be a time interval since the first UE received the wireless message at 702 (e.g., a time T2-T1), which may assist the second UE in deciding whether to receive the wireless message from the first UE as described below.

It is noted that an age of the wireless message may indicate a time interval since the wireless message was received by any UE from a network node. For example, if the first UE receives the wireless message at 702 from the third UE rather than from the network node, and if the third UE received the wireless message from a network node at a third time T3 (where T3 occurs before T1), then the time interval included at 708 by the first UE may be the time since the third time (e.g., T2-T3). For example, the first UE may receive an age T1-T3 of the wireless message from the third UE along with the wireless message and may increase the age by the extra message time at the first UE (T2-T1) resulting in an age T2-T3 which may be indicated by the first UE at 708.

As shown by reference number 710, the first UE may receive, from the second UE, a response to the discovery initiation message. The response may indicate that the second UE has not yet received the wireless message, may not yet have received the wireless message (e.g., due to being out of network coverage), or simply that the second UE requests the first UE to transfer the wireless message. Alternatively, the response itself may be an indication that the second UE has not, or may not yet have, received the wireless message. When the second UE has already received the wireless message or decides (e.g., based on the indication or indications of characteristics of the wireless message received at 708) not to receive the wireless message, the second UE may not transmit the response to the first UE. For example, the second UE may decide not to receive the wireless message if a type of alerting event indicated at 708 does not correspond to a disaster event, if the second UE has already received a wireless message with the same message identifier or serial number as indicated at 708, if the second UE is not in or not near to a target area for the wireless message, or if an age of the wireless message indicated at 708 exceeds a preconfigured threshold. Conversely, the second UE may decide to receive the wireless message if none of the previous conditions are indicated and may then send the response at 710.

As shown by reference number 712, the first UE may transmit, to the second UE, the wireless message in accordance with a store-and-forward operation and in response to the response at 710. The first UE may transmit the wireless message to the second UE when the second UE is, or may be, in or near to the target area for the wireless message if the first UE can determine this. For example, the first UE may know its own location (e.g., which may be determined by the first UE using GPS, GNSS, WLAN or other methods) and may know an approximate or maximum distance from the first UE to the second UE, which may enable the first UE to determine an area within which the second UE is located. If at least a portion of this area is within the target area or close to the target area, the first UE may proceed with the operation at 708 and the operation at 712.

The operations at 708, 710 and 712 may be referred to as a “Push” method for transferring the wireless message because a UE that has received the wireless message (in this case the first UE) instigates transfer of the wireless message to a UE that has not yet received the wireless message (in this case the second UE). The messages transferred at each of the operations at 708, 710 and 712 may be ProSe messages in one aspect. The first UE may perform the push method at 708, 710 and 712 when the first UE receives the indication for the first UE to convey the wireless message to other UEs in a target area. For example, the indication may be a flag and the first UE may perform the operations at 708, 710 and 712 when the flag is set to ON. Alternatively, the first UE may perform the operations at 708, 710 and 712 when the first UE receives an indication to use a Push method to convey the wireless message to other UEs in a target area. The first UE may not transmit the wireless message to UEs that are known to be outside of the target area. The first UE may verify that the second UE is within (or close to) the target area before transmitting the wireless message, which may be based at least in part on an interaction between the first UE and the second UE. The first UE may transmit the wireless message at the second time (T2), which may occur after the first time. The first UE may transmit the wireless message via the sidelink interface. The first UE may transmit the wireless message at the second location. Further, the first UE may include the indication received at 708 with the wireless message transmitted to the second UE, which may enable the second UE to further propagate the wireless message to other UEs in the target area.

In some aspects, the store-and-forward operation may be associated with a validity time for the wireless message that may be received at 702 along with the wireless message or as part of the wireless message. The first UE may send the validity time along with wireless message to the second UE at 712. The first UE may stop forwarding the wireless message after an expiry of the validity time. In some aspects, the first UE may receive the wireless message from the network node (or third UE) and transmit the wireless message to the second UE using a same RAT. Alternatively, the first UE may receive the wireless message from the network node (or third UE) and transmit the wireless message to the second UE using different RATs. For example, the first UE may receive the wireless message from the network node at 702 using a 4G or 5G satellite RAT and may transmit the wireless message to the second UE at 712 using a 4G or 5G terrestrial RAT.

In some aspects, a WEA message transfer using sidelink signaling may be enhanced by using the store-and-forward operation. A WEA message that is received by the first UE over any RAT and from any public land mobile network (PLMN) at the first time may be later forwarded at the second time and over a possibly different RAT to another UE, such as the second UE. The store-and-forward operation may be associated with a UE diffusion property, such that some proportion of UEs that receive the WEA message in real-time using an active backhaul from the base station or from another UE may, over a period of time referred to as a UE diffusion time, diffuse over much or all of the target WEA area, thereby enabling all or most UEs in the target WEA area (who support a store-and-forward capability) to receive the WEA message. The UE diffusion time may range from minutes to hours depending on the extent of the backhaul outage and the size of the target WEA area. The UE diffusion time may also depend on WEA messages that do not cause UEs to immediately stay out of the target area. With these conditions, a store-and-forward transfer using sidelink signaling may be able to at least partly overcome wireless coverage that is partly or entirely unavailable in the target WEA area.

The store-and-forward operation may also be associated with a message diffusion property, such that a WEA message may diffuse, over a period of time referred to as a message diffusion time, over much or all of the target WEA area by being passed along a chain of UEs, or along a number of chains of UEs, thereby enabling all or most UEs in the target WEA area (that support a store-and-forward capability) to receive the WEA message. Here, the UEs may not move or may move by only short distances during the message diffusion time. The message diffusion time may range from less than a minute to a few minutes depending on an extent of a backhaul outage. a size of the target WEA area and a density of UEs in the target WEA area.

In some aspects, the WEA message transfer may avoid processing and signaling impacts to UEs. The WEA message transfer may avoid forwarding WEA messages during times when WEA message forwarding is not needed (e.g., when wireless coverage is not disabled). For example, the wireless message received by the first UE at 702 may not then be associated with an indication for the first UE to convey the wireless message to other UEs in a target area, which may cause the first UE to not perform the operations at 708, 710 and 712. The WEA message transfer may maximize WEA message forwarding using sidelink store-and-forward operations when the wireless coverage is disabled, for example as described for FIGS. 6A and 6B. The network node broadcasting the WEA message may optionally include the indication, where the indication may indicate that UE assistance (in the form of the sidelink store-and-forward operation) is needed to further convey the WEA message to other UEs in the target WEA area. The indication may be a single bit or single parameter in the WEA broadcast channel (e.g., SIB), a bit or parameter inside the WEA message, or a new type of WEA message. UEs that receive the indication may then actively attempt to forward the WEA message to other UEs without wireless coverage and that have not yet received the WEA message. For example, a UE with a WEA message may initiate discovery of other UEs and indicate in a discovery initiation that a purpose is to forward the WEA message (or messages)—e.g., as in the Push method shown in FIG. 7.

In some aspects, messages such as non-WEA messages (e.g., for an alerting event that is not a disaster event) may be conveyed to UEs that are out-of-coverage with the network node, similar to WEA messages. Such messages may include public safety (PS) messages, which may be transferred to all PS UEs via PS UEs that initially have wireless coverage with the network node. Such messages may include notifications to UEs in a closed group (e.g., UEs belonging to employees of a company or organization), where such notifications may be transferred to all UEs in the closed group via UEs with initial coverage. Such messages may indicate where wireless coverage is available, and the messages may be transmitted to all UE subscribers of a PLMN via other UEs of the PLMN when a PLMN experiences loss of coverage over some of its coverage area.

As indicated above, FIG. 7 is provided as an example. Other examples may differ from what is described with regard to FIG. 7.

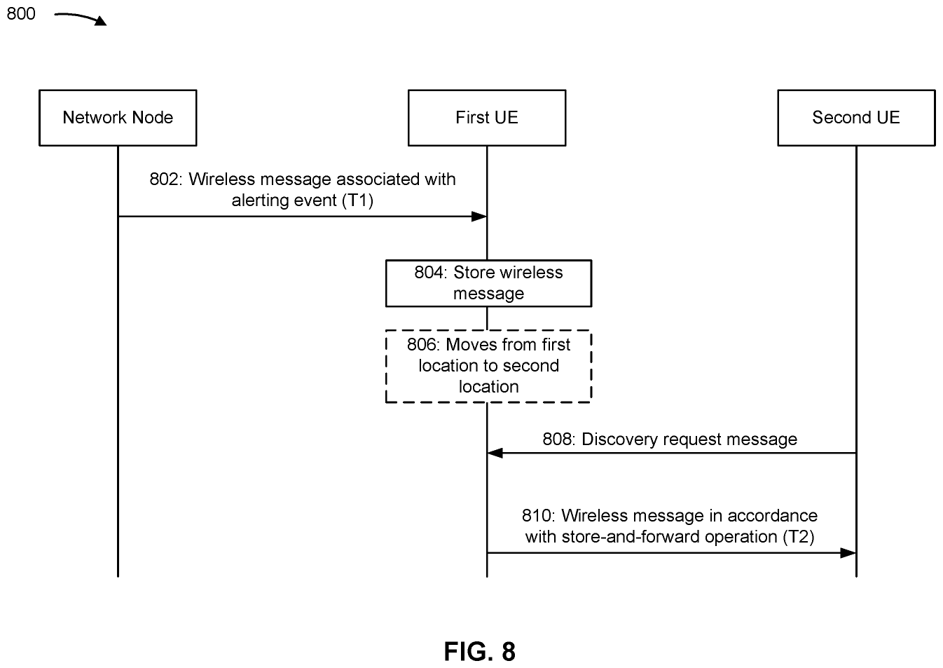

FIG. 8 is a diagram illustrating an example 800 associated with transmitting wireless messages during an alerting event, in accordance with the present disclosure. As shown in FIG. 8, example 800 includes communication between a network node (e.g., network node 110), a first UE (e.g., UE 120a), and a second UE (e.g., UE 120e). In some aspects, the network node, the first UE, and the second UE may be included in a wireless network, such as wireless network 100.

As shown by reference number 802, the first UE may receive, from the network node, a wireless message that indicates an alerting event. The alerting event may involve a natural disaster, a man-made disaster, and/or a loss of coverage to a wireless network. The wireless message may be a WEA message. The first UE may receive the wireless message at a first time (T1) and at a first location. The first UE may receive the wireless message from the network node via a broadcast when the first UE is in-coverage with the network node, e.g., as described for FIGS. 3-5. Alternatively, the first UE may receive the wireless message from a third UE (not shown in FIG. 8) via a sidelink interface, where the third UE may have received the wireless message from a network node or from another UE via a sidelink interface.

In some aspects, the wireless message may be associated with an indication for the first UE to convey or not convey the wireless message to other UEs in a target area. For example, the indication may indicate that first UE does not use a Push method as in FIG. 7, but may or shall use a Pull method as described below or does not transfer the wireless message to other UEs using any method. For example, the indication may be a flag. When the flag is set to OFF, the first UE may be configured to not automatically convey the wireless message to other UEs in the target area (e.g., using a Push method) but to instead convey the wireless message to other UEs in the target area only when requested, e.g., using a Pull method as described below, which may be useful when network nodes are not damaged and are still operable.

As shown by reference number 804, the first UE may store the wireless message in a memory of the first UE. The first UE may store the wireless message for a certain period of time (e.g., a validity time that may be received at 802 along with the wireless message), after which the first UE may erase the wireless message from the memory of the first UE.

As shown by reference number 806, the first UE may move from the first location to a second location. In other words, the UE may be a mobile UE, and after receiving the wireless message at the first location, the first UE may move to the second location. The second location may be different from the first location. The second location may be outside of a coverage area of the network node (e.g., there is no wireless network coverage at the second location). In some aspects, the first UE may remain at or near to the first location and 806 may not occur.

As shown by reference number 808, the first UE may receive, from the second UE, a discovery request message that indicates that a purpose of the discovery request message is to receive the wireless message. In other words, the second UE may broadcast a request for the wireless message (e.g., to all UEs nearby to the second UE), where the request may be received by the first UE. In this case, the first UE may not be configured by the network node at 802 to propagate the wireless message to other UEs in a target area, e.g., using a Push method as in FIG. 7. However, by transmitting the discovery request message ay 808, the second UE may advertise that the second UE has not received any wireless messages for a period of time (e.g., because the second UE is out of network coverage). The first UE may receive the discovery request message at a second time (T2) and after moving to the second location if 806 occurs. In other words, at the second time and possibly after moving to the second location, which may be out-of-coverage with the network node, the first UE may receive the request from the second UE that would otherwise not be able to receive the wireless message. The second UE may be out-of-coverage with the network node.

As shown by reference number 810, the first UE may transmit, to the second UE, the wireless message in accordance with a store-and-forward operation. The first UE may transmit the wireless message to the second UE when the second UE is, or may be, in the target area (or close to the target area) for the wireless message. The first UE may transmit the wireless message only when the first UE has received an indication at 802 for the first UE to convey the wireless message to other UEs in a target area when requested or, in some other aspects, when no indication for transferring the wireless message was received at 802. For example, if the indication is a flag and the flag is set to OFF, the first UE may transfer the wireless message based at least in part on the discovery request message. The first UE may not transmit the wireless message to the second UE without first receiving the discovery request message. The first UE may transmit the wireless message at a second time (T2), which may occur after the first time. The first UE may transmit the wireless message via the sidelink interface. The first UE may transmit the wireless message at the second location. The first UE may include at 810 any indication received at 802 to convey the wireless message to other UEs in a target area when requested.

The operations at 808 and 810 may be referred to as a “Pull” method for transferring the wireless message because a UE that has not yet received the wireless message (in this case the second UE) needs to first send a request for the wireless message to a UE that has received the wireless message (in this case the first UE) in order to receive the wireless message. The messages transferred at each of the operations at 808 and 810 may be ProSe messages in one aspect.

As indicated above, FIG. 8 is provided as an example. Other examples may differ from what is described with regard to FIG. 8.

A possible problem with transferring a wireless message from a first UE to a second UE using a sidelink interface (e.g., as illustrated in FIGS. 6A, 6B. 7 and 8) is that the second UE may not know whether the wireless message is authentic. For example, an attacker could use the first UE to transfer a spoofed wireless message containing false information to other UEs (e.g., the second UE) in order to cause inappropriate, unnecessary undesirable, and/or dangerous behavior by the users of the other UEs. For example, the inappropriate, unnecessary, undesirable, and/or dangerous behavior might include movement of users away from an area or location, movement of users towards an area or location, general panic, congestion of roads, congestion of communication systems, congestion and injury in a confined space (e.g., sports stadium or concert arena), and/or physical violence.

To overcome and avoid the above problem, the first UE could transfer authentication information along with the wireless message to the second UE (e.g., at 712 in FIG. 7 or 810 in FIG. 8), where the authentication information enables the second UE to verify an authenticity of the wireless message, and where the wireless message may include a target area and a validity time for the wireless message. For example, the authentication information may comprise a digital signature for the wireless message (e.g., a digital signature for the content of the wireless massage and the target area and validity time if not part of the content of the wireless message). The digital signature may be created using a private authentication key known only to the original sender of the wireless message (e.g., a government agency, network operator or other trusted party). The private authentication key may be associated with a public authentication key that is widely available (e.g., for an RSA or elliptic curve private key-public pair). The public key may already be known to the second UE or may be provided to the second UE in a key certificate (e.g., an ITU defined key certificate). The key certificate may be part of the authentication information transferred to the second UE by the first UE or may be preconfigured in the second UE—e.g., by a home PLMN operator for the second UE. The second UE may verify the correctness of the digital signature using the public authentication key. If the digital signature is verified, the second UE may consider the wireless message including any validity time and/or target area to be authentic and May present the wireless message to a user of the second UE if the second UE is in the target area for the wireless message and if the validity time has not yet expired. The second UE may also transfer the wireless message to other UEs along with the authentication information if the validity time has not yet expired. If the digital signature is not verified, the second UE may discard the wireless message. The first UE may receive the authentication information along with the wireless message from a network node via a broadcast or from a third UE via a sidelink interface (e.g., as at 702 in FIG. 7 or 802 in FIG. 8) and may verify the authenticity of the wireless message using the public key in the same way as the second UE before sending the wireless message to the second UE.

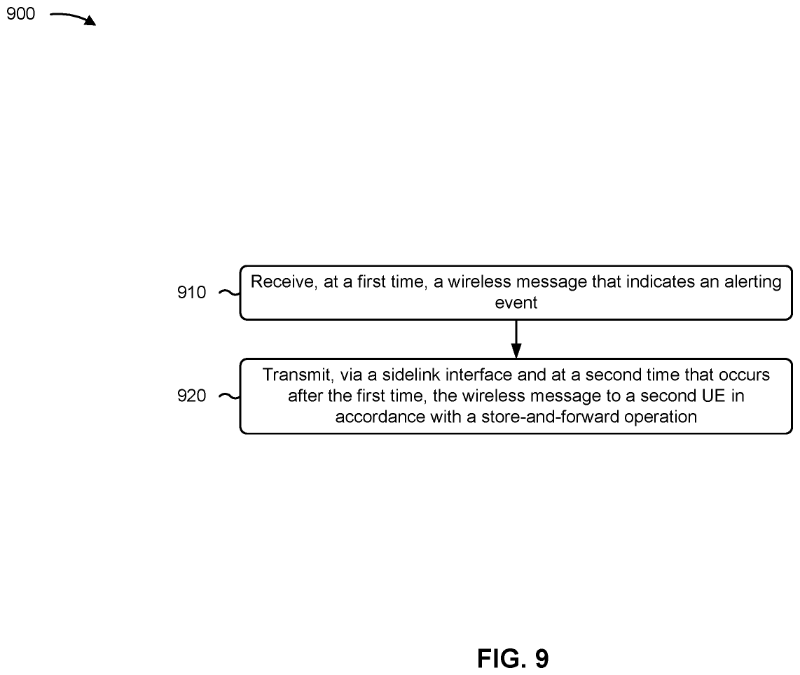

FIG. 9 is a diagram illustrating an example process 900 performed, for example, at a first UE or an apparatus of a first UE, in accordance with the present disclosure. Example process 900 is an example where the apparatus or the first UE (e.g., UE 120a) performs operations associated with transmitting wireless messages during an alerting event.

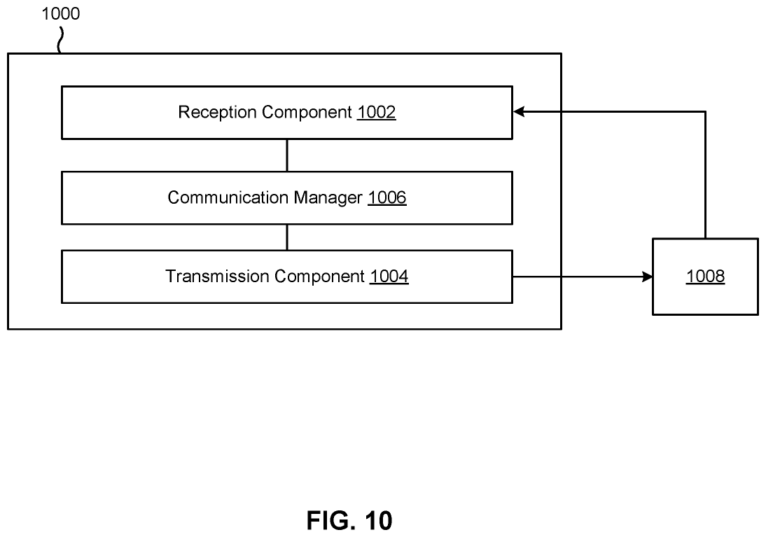

As shown in FIG. 9, in some aspects, process 900 may include receiving, at a first time, a wireless message that indicates an alerting event (block 910), e.g., as described for 702 in FIGS. 7 and 802 in FIG. 8. For example, the first UE (e.g., using reception component 1002 and/or communication manager 1006, depicted in FIG. 10) may receive, at a first time, a wireless message that indicates an alerting event, as described above.

As further shown in FIG. 9, in some aspects, process 900 may include transmitting, via a sidelink interface and at a second time that occurs after the first time, the wireless message to a second UE in accordance with a store-and-forward operation (block 920), e.g., as described for 712 in FIGS. 7 and 810 for FIG. 8. For example, the first UE (e.g., using transmission component 1004 and/or communication manager 1006, depicted in FIG. 10) may transmit, via a sidelink interface and at a second time that occurs after the first time, the wireless message to a second UE in accordance with a store-and-forward operation, as described above.

Process 900 may include additional aspects, such as any single aspect or any combination of aspects described below and/or in connection with one or more other processes described elsewhere herein.

In a first aspect, the wireless message is a WEA message.

In a second aspect, alone or in combination with the first aspect, the alerting event comprises one or more of a natural disaster, a man-made disaster, or a loss of coverage to a wireless network.

In a third aspect, alone or in combination with one or more of the first and second aspects, process 900 includes transmitting the wireless message to the second UE when the second UE is in a target area for the wireless message.

In a fourth aspect, alone or in combination with one or more of the first through third aspects, process 900 includes receiving the wireless message from a network node (e.g., a network node 110) via a broadcast, e.g., as described for 702 for FIGS. 7 and 802 for FIG. 8.

In a fifth aspect, alone or in combination with one or more of the first through fourth aspects, process 900 includes receiving the wireless message from a third UE via the sidelink interface, e.g., as described for 702 for FIGS. 7 and 802 for FIG. 8 and for FIGS. 6A and 6B.

In a sixth aspect, alone or in combination with one or more of the first through fifth aspects, the wireless message is received and the wireless message is transmitted using a same RAT.

In a seventh aspect, alone or in combination with one or more of the first through sixth aspects, the wireless message is received and the wireless message is transmitted using different RATs.

In an eighth aspect, alone or in combination with one or more of the first through seventh aspects, the first UE has a first location at the first time and a second location at the second time, where the first location is different from the second location, and where no wireless network coverage is present at the second location, e.g., as described for FIG. 6A.

In a ninth aspect, alone or in combination with one or more of the first through eighth aspects, the wireless message is associated with an indication for the first UE to convey the wireless message to other UEs, and the indication and the wireless message are included in a SIB transmitted by a network node via a broadcast channel or in sidelink communication from a third UE. e.g., as described for FIGS. 7 and 8.

In a tenth aspect, alone or in combination with one or more of the first through ninth aspects, process 900 includes including the indication with the wireless message transmitted to the second UE, e.g., as described for FIGS. 7 and 8.

In an eleventh aspect, alone or in combination with one or more of the first through tenth aspects, process 900 includes transmitting, to the second UE, a discovery initiation message that indicates that a purpose of the discovery initiation message is to forward the wireless message, receiving, from the second UE, a response to the discovery initiation message, and transmitting the wireless message to the second UE based at least in part on the response, e.g., as described for 708, 710 and 712 for FIG. 7.

In a twelfth aspect, alone or in combination with one or more of the first through eleventh aspects, process 900 includes receiving, from the second UE, a discovery request message that indicates that a purpose of the discovery request message is to receive the wireless message, and transmitting the wireless message to the second UE based at least in part on the discovery request message, e.g., as described for 808 and 810 for FIG. 8.

In a thirteenth aspect, alone or in combination with one or more of the first through twelfth aspects, the first UE is in-coverage with a network node, and the second UE is out-of-coverage with any network node, e.g., as described for FIG. 6A.

In a fourteenth aspect, alone or in combination with one or more of the first through thirteenth aspects, the wireless message is a public safety message.

In a fifteenth aspect, alone or in combination with one or more of the first through fourteenth aspects, the first UE and the second UE are associated with a closed group of UEs.

In a sixteenth aspect, alone or in combination with one or more of the first through fifteenth aspects, process 900 includes sending authentication information along with the wireless message to the second UE, where the authentication information enables the second UE to authenticate the wireless message. The authentication information may comprise a public authentication key, a certificate for the public authentication key, a digital signature, or some combination of these. Process 900 may further include receiving the authentication information along with the wireless message from a network node via a broadcast. Process 900 may also include receiving the authentication information along with the wireless message from a third UE via the sidelink interface. Process 900 may further include authenticating the wireless message using the authentication information prior to transmitting the wireless message to the second UE.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE (e.g., a UE 120), a first UE (e.g., a UE 120a), or a UE or first UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 140 described in connection with FIG. 1. As shown, the apparatus 1000 may communicate with another apparatus 1008, such as another UE (e.g., a UE 120) or a network node (e.g., a network node 110 which may be a CU, a DU, an RU, or a base station), using the reception component 1002 and the transmission component 1004.

In some aspects, the apparatus 1000 may be configured to perform one or more operations described herein in connection with FIGS. 6A-8. Additionally, or alternatively, the apparatus 1000 may be configured to perform one or more processes described herein, such as process 900, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with the UE in FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, sidelink signaling or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1004 may transmit communications, such as reference signals, control information, data communications, sidelink signaling, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1004 may be co-located with the reception component 1002 in one or more transceivers.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive, at a first time, a wireless message that indicates an alerting event. The transmission component 1004 may transmit, via a sidelink interface and at a second time that occurs after the first time, the wireless message to a second UE in accordance with a store-and-forward operation.

The transmission component 1004 may transmit the wireless message to the second UE when the second UE is in a target area for the wireless message. The reception component 1002 may receive the wireless message from a network node via a broadcast. The reception component 1002 may receive the wireless message from a third UE via the sidelink interface. The reception component 1002 may receive the wireless message and transmit the wireless message using a same RAT. The reception component 1002 may receive the wireless message and transmit the wireless message using a different RAT. The communication manager 1006 may include an indication with the wireless message transmitted to the second UE that the second UE is to transfer the wireless message to other UEs.

The transmission component 1004 may transmit, to the second UE, a discovery initiation message that indicates that a purpose of the discovery initiation message is to forward the wireless message. The reception component 1002 may receive, from the second UE, a response to the discovery initiation message, wherein the one or more processors are configured to cause the first UE to transmit the wireless message to the second UE based at least in part on the response. The reception component 1002 may receive, from the second UE, a discovery request message that indicates that a purpose of the discovery request message is to receive the wireless message, wherein the one or more processors are configured to cause the first UE to transmit the wireless message to the second UE based at least in part on the discovery request message.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a first user equipment (UE), comprising: receiving, at a first time, a wireless message that indicates an alerting event; and transmitting, via a sidelink interface and at a second time that occurs after the first time, the wireless message to a second UE in accordance with a store-and-forward operation.

Aspect 2: The method of Aspect 1, wherein the wireless message is a wireless emergency alert (WEA) message.

Aspect 3: The method of any of Aspects 1-2, wherein the alerting event comprises one or more of: a natural disaster, a man-made disaster, or a loss of coverage to a wireless network.

Aspect 4: The method of any of Aspects 1-3, wherein transmitting the wireless message comprises transmitting the wireless message to the second UE when the second UE is in a target area for the wireless message.

Aspect 5: The method of any of Aspects 1-4, wherein receiving the wireless message comprises receiving the wireless message from a network node via a broadcast.

Aspect 6: The method of any of Aspects 1-5, wherein receiving the wireless message comprises receiving the wireless message from a third UE via the sidelink interface.

Aspect 7: The method of any of Aspects 1-6, wherein the wireless message is received and the wireless message is transmitted using a same radio access technology (RAT).

Aspect 8: The method of any of Aspects 1-7, wherein the wireless message is received and the wireless message is transmitted using different radio access technologies (RATs).

Aspect 9: The method of any of Aspects 1-8, wherein the first UE has a first location at the first time and a second location at the second time, the first location is different from the second location, and no wireless network coverage is present at the second location.

Aspect 10: The method of any of Aspects 1-9, wherein the wireless message is associated with an indication for the first UE to convey the wireless message to other UEs, and wherein the indication and the wireless message are included in a system information block (SIB) transmitted by a network node via a broadcast channel or in sidelink communication from a third UE.

Aspect 11: The method of Aspect 10, further comprising: including the indication with the wireless message transmitted to the second UE.

Aspect 12: The method of any of Aspects 1-11, further comprising: transmitting, to the second UE, a discovery initiation message that indicates a purpose of the discovery initiation message is to forward the wireless message; and receiving, from the second UE, a response to the discovery initiation message, wherein the one or more processors are configured to cause the first UE to transmit the wireless message to the second UE based at least in part on the response.

Aspect 13: The method of any of Aspects 1-12, further comprising: receiving, from the second UE, a discovery request message that indicates a purpose of the discovery request message is to receive the wireless message, wherein the one or more processors are configured to cause the first UE to transmit the wireless message to the second UE based at least in part on the discovery request message.

Aspect 14: The method of any of Aspects 1-13, wherein the first UE is in-coverage with a network node, and the second UE is out-of-coverage with any network node.

Aspect 15: The method of any of Aspects 1-14, wherein the wireless message is a public safety message.

Aspect 16: The method of any of Aspects 1-15, wherein the first UE and the second UE are associated with a closed group of UEs.

Aspect 17: The method of any of Aspects 1-16, further comprising: sending authentication information along with the wireless message to the second UE, wherein the authentication information enables the second UE to authenticate the wireless message, wherein the authentication information comprises a public authentication key, a certificate for the public authentication key, a digital signature, or some combination of these.

Aspect 18: The method of any of Aspects 1-16, further comprising: receiving authentication information along with the wireless message from a network node via a broadcast.

Aspect 19: The method of any of Aspects 1-16, further comprising: receiving authentication information along with the wireless message from a third UE via the sidelink interface,

Aspect 20: The method of any of Aspects 1-16, further comprising: authenticating the wireless message using authentication information prior to transmitting the wireless message to the second UE.

Aspect 21: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-20.

Aspect 22: An apparatus for wireless communication at a device, the apparatus comprising one or more memories and one or more processors coupled to the one or more memories, the one or more processors configured to cause the device to perform the method of one or more of Aspects 1-20.

Aspect 23: An apparatus for wireless communication, the apparatus comprising at least one means for performing the method of one or more of Aspects 1-20.

Aspect 24: A non-transitory computer-readable medium storing code for wireless communication, the code comprising instructions executable by one or more processors to perform the method of one or more of Aspects 1-20.

Aspect 25: A non-transitory computer-readable medium storing a set of instructions for wireless communication, the set of instructions comprising one or more instructions that, when executed by one or more processors of a device, cause the device to perform the method of one or more of Aspects 1-20.

Aspect 26: A device for wireless communication, the device comprising a processing system that includes one or more processors and one or more memories coupled with the one or more processors, the processing system configured to cause the device to perform the method of one or more of Aspects 1-20.

Aspect 27: An apparatus for wireless communication at a device, the apparatus comprising one or more memories and one or more processors coupled to the one or more memories, the one or more processors individually or collectively configured to cause the device to perform the method of one or more of Aspects 1-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a +a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a first user equipment (UE), comprising:
one or more memories; and
one or more processors, coupled to the one or more memories, configured to cause the first UE to:
receive, at a first time, a wireless message that indicates an alerting event; and
transmit, via a sidelink interface and at a second time that occurs after the first time, the wireless message to a second UE in accordance with a store-and-forward operation.

2. The apparatus of claim 1, wherein the wireless message is a wireless emergency alert (WEA) message.

3. The apparatus of claim 1, wherein the alerting event comprises one or more of: a natural disaster, a man-made disaster, or a loss of coverage to a wireless network.

4. The apparatus of claim 1, wherein the one or more processors are configured to cause the first UE to:
transmit the wireless message to the second UE when the second UE is in a target area for the wireless message.

5. The apparatus of claim 1, wherein the one or more processors are configured to cause the first UE to:
receive the wireless message from a network node via a broadcast.

6. The apparatus of claim 1, wherein the one or more processors are configured to cause the first UE to:
receive the wireless message from a third UE via the sidelink interface.

7. The apparatus of claim 1, wherein the one or more processors are configured to cause the first UE to:
receive the wireless message and transmit the wireless message using a same radio access technology (RAT).

8. The apparatus of claim 1, wherein the one or more processors are configured to cause the first UE to:
receive the wireless message and transmit the wireless message using different radio access technologies (RATs).

9. The apparatus of claim 1, wherein the first UE has a first location at the first time and a second location at the second time, the first location is different from the second location, and no wireless network coverage is present at the second location.

10. The apparatus of claim 1, wherein the wireless message is associated with an indication for the first UE to convey the wireless message to other UEs, and
wherein the indication and the wireless message are included in a system information block (SIB) transmitted by a network node via a broadcast channel or in sidelink communication from a third UE.

11. The apparatus of claim 10, wherein the one or more processors are further configured to cause the first UE to:
include the indication with the wireless message transmitted to the second UE.

12. The apparatus of claim 1, wherein the one or more processors are further configured to cause the first UE to:
transmit, to the second UE, a discovery initiation message that indicates a purpose of the discovery initiation message is to forward the wireless message; and
receive, from the second UE, a response to the discovery initiation message, wherein the one or more processors are configured to cause the first UE to transmit the wireless message to the second UE based at least in part on the response.

13. The apparatus of claim 1, wherein the one or more processors are further configured to cause the first UE to:
receive, from the second UE, a discovery request message that indicates a purpose of the discovery request message is to receive the wireless message, wherein the one or more processors are configured to cause the first UE to transmit the wireless message to the second UE based at least in part on the discovery request message.

14. The apparatus of claim 1, wherein the first UE is in-coverage with a network node, and the second UE is out-of-coverage with any network node.

15. The apparatus of claim 1, wherein the wireless message is a public safety message.

16. The apparatus of claim 1, wherein the first UE and the second UE are associated with a closed group of UEs.

17. The apparatus of claim 1, wherein the one or more processors are configured to cause the first UE to:
send authentication information along with the wireless message to the second UE, wherein the authentication information enables the second UE to authenticate the wireless message, wherein the authentication information comprises a public authentication key, a certificate for the public authentication key, a digital signature, or some combination of these.

18. The apparatus of claim 1, wherein the one or more processors are configured to cause the first UE to:
receive authentication information along with the wireless message from a network node via a broadcast.

19. The apparatus of claim 1, wherein the one or more processors are configured to cause the first UE to:
receive authentication information along with the wireless message from a third UE via the sidelink interface.

20. The apparatus of claim 1, wherein the one or more processors are configured to cause the first UE to:
authenticate the wireless message using authentication information prior to transmitting the wireless message to the second UE.
